(19) United States
(12) Patent Application Publication
(10) Pub. No.: US 2006/0149571 A1
(43) Pub. Date: Jul. 6, 2006

(54) Multi-channel enterprise communication management framework

(76) Inventors: Rodney Birch, Dublin (IE); Peter Maxwell, Dublin (IE)

Correspondence Address: SMITH FROHWEIN TEMPEL GREENLEE BLAHA, LLC, P.O. BOX 88148, ATLANTA, GA, 30356, US

(21) Appl. No.: 11/027,506

(22) Filed: Dec. 30, 2004

(51) Int. Cl. G06Q 99/00

(52) U.S. Cl. 705/1

(57) ABSTRACT

Various embodiments of systems, methods, computer programs, etc. for unifying management of customer messages and responses in an enterprise across a plurality of channels are provided. One embodiment is an enterprise system comprising: a plurality of enterprise applications for interacting with customers via a plurality of channels; and a communication management framework for managing messages to be presented to the customers and customer responses to the messages across the plurality of enterprise applications.

### BACKGROUND

It is common for various types of enterprises to employ multiple channels of interaction with enterprise customers. The channels may be characterized by applications, technologies, presentation logic requirements, business endpoints, consumer interactions, employee interactions, delivery methods, etc. In the example of a financial services provider, the enterprise may support full-service channels (e.g., bank branch, call center, etc.) for human-to-human interactions, self-service channels (e.g., Internet, interactive voice response (IVR) system, automated teller machine (ATM), etc.) for human-to-machine interactions, and automated channels (e.g., open financial exchange (OFX) transactions, web services, etc.) for machine-to-machine interactions.

Competition and the proliferation of products, services, and additional channels of customer interaction have significantly increased the complexity of managing customer communications, responses, interactions, etc. As will be appreciated with reference to the description below, however, existing solutions for managing customer communications in an enterprise have various limitations. Therefore, there is a need in the art for systems, methods, computer programs, etc. for unifying management of customer messages and responses in an enterprise across a plurality of channels.

### SUMMARY

Various embodiments of systems, methods, computer programs, etc. for unifying management of customer messages and responses in an enterprise across a plurality of channels are provided. One embodiment is an enterprise system comprising: a plurality of enterprise applications for interacting with customers via a plurality of channels; and a communication management framework for managing messages to be presented to the customers and customer responses to the messages across the plurality of enterprise applications.

Another embodiment comprises a service-oriented, enterprise platform for providing banking solutions to financial service providers. One such enterprise platform comprises: a communication management framework for managing messages to be presented to customers of a financial service provider across a plurality of enterprise channels and for managing customer responses to the messages, the communication management framework comprising: a message object defining a message to be presented to at least one of the customers; a channel-specific object representing channel-specific content associated with the message; and a customer interaction object representing a planned customer interaction associated with the message; and a data repository for storing the messages and the customer responses to the messages.

Yet another embodiment comprises a multi-channel enterprise communication management framework (MECMF) embodied in a computer-readable medium for unifying customer messages and responses in an enterprise across a plurality of channels. One such MECMF comprises: a message object defining a message to be presented to at least one of the customers; a channel-specific object representing channel-specific content associated with the message; and a customer interaction object representing a planned customer interaction associated with the message.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram of one of a number of embodiments of an enterprise system in which a multi-channel enterprise communication management framework (MECMF) may be implemented.

FIG. 2 is a block diagram illustrating an embodiment of the MECMF of FIG. 1.

FIG. 3 is a flow chart illustrating the architecture, operation, and/or functionality of an embodiment of the MECMF of FIGS. 1 & 2.

FIG. 4 is a Unified Modeling Language (UML) diagram illustrating the base relationships of an embodiment of the MECMF of FIGS. 1-3.

FIG. 5 is a UML diagram illustrating another embodiment of the MECMF of FIGS. 1-3.

FIG. 6 is a UML diagram illustrating yet another embodiment of the MECMF of FIGS. 1-3.

FIG. 7 is a UML diagram illustrating a further embodiment of the MECMF of FIGS. 1-3.

FIG. 8 is a block diagram illustrating another embodiment of an enterprise system in which a MECMF may be implemented.

### DETAILED DESCRIPTION

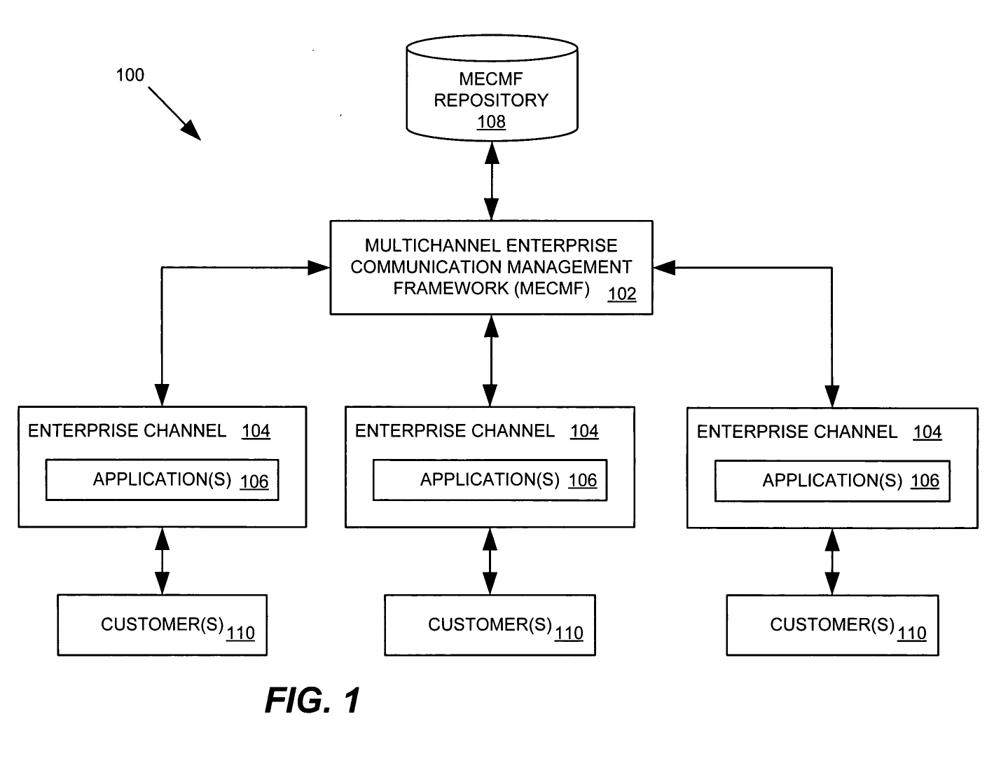

Various embodiments of systems, methods, computer programs, etc. for unifying management of customer messages and responses in an enterprise via a plurality of channels are provided. Various embodiments are described below with respect to FIGS. 1-8. As an introductory matter, however, one embodiment of a multi-channel enterprise communication management framework (MECMF) will be briefly described. In general, the MECMF provides a unified mechanism for managing communications, interactions, etc. with customers in an enterprise across a plurality of enterprise channels. The MECMF may be implemented in a services-oriented architecture by an enterprise platform that provides business services to applications across multiple channels in the enterprise. In one embodiment, the enterprise platform functions as a front-end provider of banking solutions to financial services providers. It should be appreciated, however, that the enterprise platform (and the MECMF) may be configured to support any type of enterprise depending on the particular functionality of the business services, applications, etc. Furthermore, the MECMF need not be implemented in the enterprise platform and, in alternative embodiments, may be integrated within the enterprise.

The enterprise may interface with customers using various types of channels of communication, conduits of interaction, etc. with the system. The channels may be characterized by applications, technologies, presentation logic requirements, business endpoints, consumer interactions, employee interactions, delivery methods, etc. In the example of a financial services provider, the enterprise may support full-service channels (e.g., bank branch, call center, etc.) for human-to-human interactions, self-service channels (e.g., Internet, interactive voice response (IVR) system, automated teller machine (ATM), etc.) for human-to-machine interactions, and automated channels (e.g., open financial exchange (OFX) transactions, web services, etc.) for machine-to-machine interactions.

To meet the demands of the enterprise, various applications may be employed across the various channels and which are supported by the enterprise platform. In accordance with the service-oriented architecture, the applications may be configured using a set of underlying building blocks, services, etc. These individual services are components that are put together in a flexible manner to deliver the desired business logic. The building blocks (services) are provided by the enterprise platform and accessed by the applications. As known in the art, services implement capabilities that are available to other applications (or even other services) via industry standard network and application interfaces and protocols. An application can use the capabilities of a service (e.g., functions, data, business processes, etc.) by simply invoking it across a network without having to integrate it. In other words, services expose their capabilities to client applications—not their implementations. Therefore, services represent reusable software building blocks. This allows services to be implemented in any language and on any platform and still be compatible with client applications.

Each building block (service, software component(s), etc.) is self-contained, and describes its own capabilities, publishes its own programmatic interface, and implements its own functionality that is available as a hosted service via the enterprise platform. The business logic of the service runs on a remote machine that is accessible by the enterprise applications through multiple channels. The enterprise applications invoke the functionality of the service by sending messages/requests to the service provided by enterprise platform, receiving return messages from the service, and using the results within the application. Because there is no need to integrate the services within the enterprise applications into a single, monolithic block, development and testing times, maintenance costs, etc. may be reduced. A more detailed description of services in the form of web-based services is included in Developing Enterprise Web Services: An Architect's Guide, Chatterjee, S. and Webber, J., Prentice Hall PTR, 2004, which is hereby incorporated by reference in its entirety.

Having described the general enterprise platform environment, the architecture, operation, and/or functionality of the MECMF will be briefly described. As mentioned above, the MECMF centrally manages customer messages, responses, interactions, etc. in the enterprise across all of the channels. In this regard, the MECMF provides a cross-channel layer of control that exposes its management capabilities to all applications across the multiple channels of the enterprise. The MECMF may service message delivery requests from the applications, as well as provide for delivery of the messages to the appropriate customers in the enterprise. The applications may capture customer responses to the messages and pass the responses to the MECMF for storage in a centralized data repository. This unified communication framework across the entire enterprise provides a central point of control for all enterprise communications and/or interactions with customers. Furthermore, the MECMF may be leveraged to support various services, features, etc. and any type of customer communication (e.g., marketing messages, product/service offerings, email messages, account alerts, etc.).

FIG. 1 illustrates an embodiment of an enterprise system 100 in which an MECMF 102 may be implemented for providing unified management of customer communications across multiple channels in an enterprise. As illustrated in FIG. 1, MECMF 102 interfaces with applications 106 associated with various channels 104 in the enterprise. One or more of applications 106 may enable a customer 110 to interact with the enterprise. In this regard, it should be appreciated that communications between customer(s) 110 and the enterprise (via applications 106) may take many forms depending on the functionality of the application, the type of channel, etc. MECMF 102 may support one-way and/or two-way communication with customer(s) 110—inbound, outbound, or otherwise. As further illustrated in FIG. 1, MECMF 102 may store customer communications, responses, interactions, etc. in central repository 108.

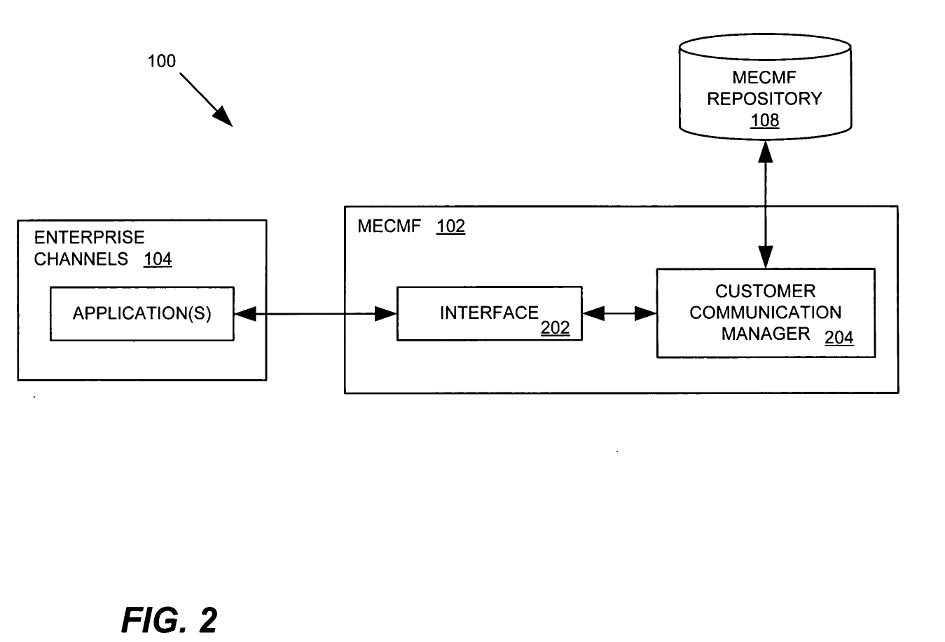

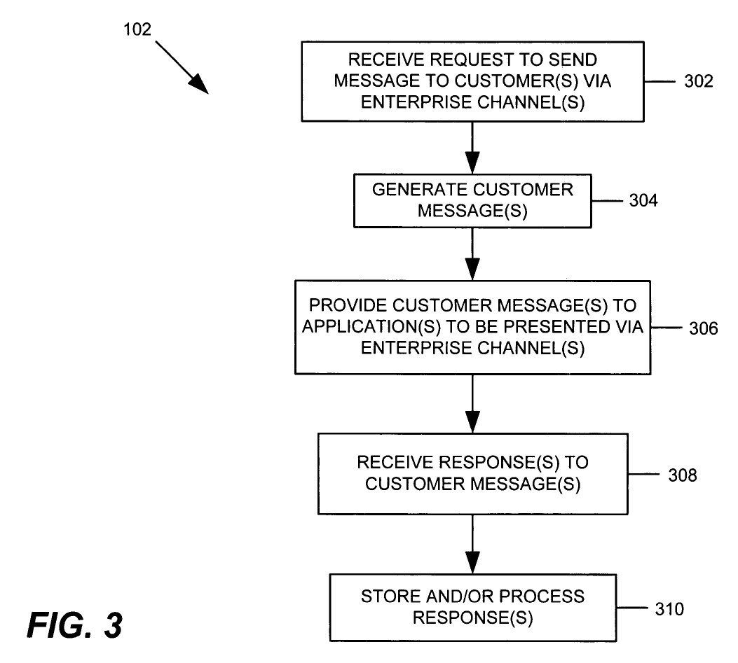

Referring to FIG. 2, MECMF 102 may include an interface 202 and a customer communication manager 204. Interface 202 enables MECMF 202 to communicate with applications 106 to, for example, receive message delivery requests, provide messages for delivery, receive customer responses to messages, etc. Customer communication manager 204 functions as the interface between repository 108 and interface 202. Customer communication manager 204 comprises the logic, functionality, etc. for controlling the operations of the unified communication framework. As illustrated in the embodiment of FIG. 3, interface 202 may receive requests from applications 104 to deliver messages to customer(s) 110 via enterprise channel(s) 104—block 302. At block 304, customer communication manager 204 may generate appropriate message(s) based on the message delivery request. At block 306, interface 202 provides the message(s) to applications 104 and, at block 308, receives customer responses to the messages from applications 104. At block 310, customer communication manager 204 may store messages and/or responses associated with customers 110 in repository 108.

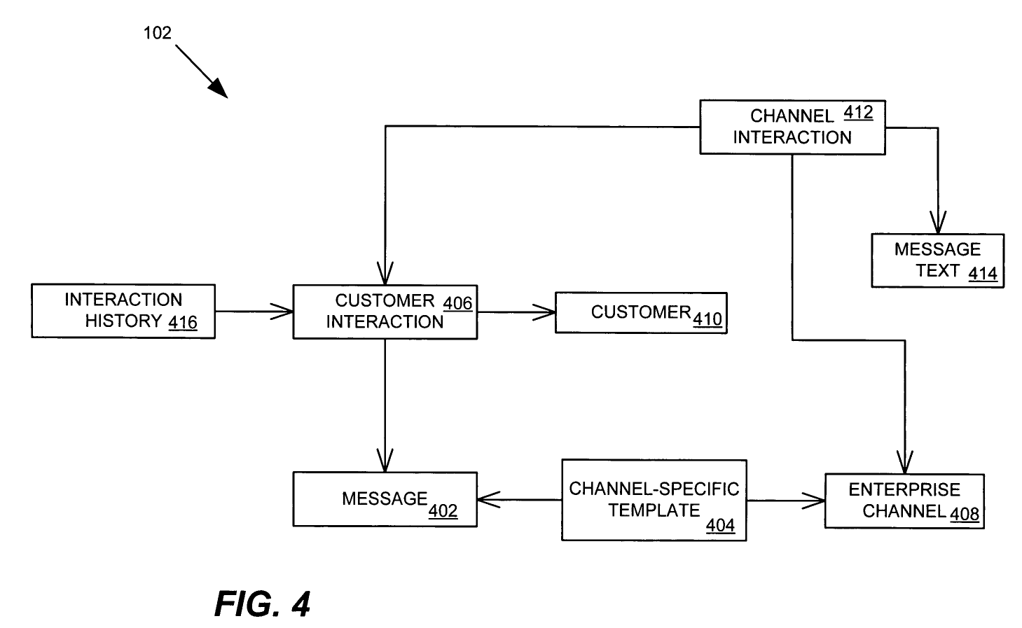

As mentioned above, MECMF 102 may be leveraged to support various services, features, etc. and any type of customer communication. Various embodiments will be described with reference to the UML diagrams illustrated in FIGS. 4-7. MECMF 102 may include any of the following, or other, types of messages: alerts, secure messages, marketing messages, and announcements. An alert comprises a message sent to a customer 110 after a pre-defined event has occurred. MECMF 102 may support functionality that determines whether a customer 110 has read an alert or not. An alert may contain the text of the alerting message. An alert may be occur on a scheduled basis (Scheduled Event) or as a result of a specific change of status (Conditional or Rule-based Event).

Alert types comprise templates that can be reused to create Alerts that follow a certain pattern. For example, an Alert template called “Checking Account Balance is under $5000” may exist for a particular application 106. An example of an object/entity model for an Alert template is described below in more detail. However, an Alert Type template can essentially be “copied” and used to create a concrete Alert type. The ability to support Alert Types (templates) may ease the administration of Alerts.

Alerts may be channel aware and present themselves with channel-specific content, parameters, etc. Alerts may also be multi-channel such that the same message can be delivered via multiple channels 104 at the same time. Alerts may be tagged as being unread or read by the customer 110. If a customer 110 receives an alert on one channel 104, all other channels 104 in the enterprise may show that the alert has been read. Alerts may have a threshold set as to the total number of times they should be presented to a customer 110. Once this threshold is met, the alert may no longer be presented. Alert thresholds can be set for each channel 104 indicating the maximum number of times this alert can be presented on this channel 104 for reading by a customer 110. Alerts may have an expiration date. Alerts that are unread at an expiration date may be made unavailable for presentation to customers 110. Alerts may be language aware such that they are presented to in the customer's language of choice. Alert definitions may be saved as templates so that they can be reused with different Rule attribute value ranges. Alert text can be integrated with text-to-speech software

Customers 110 may manage user preferences to control the alert process. For example, customers 110 may list alerts by channel, by time, by date, by type, etc. Alerts may also be triggered batch processes, background processes, etc. Alerts may be imported from other external systems and may be exported to other external systems.

A secure message is an internal message between the enterprise (e.g., financial service provider) and a customer 110. Either the enterprise or customer 110 may initiate the message. The message may be accompanied by additional data in attached file(s). Furthermore, a message can be replied to. MECMF 102 may also provide functionality determining whether the recipient has read the message.

A secure message may include any of the following, or other, attributes: author; date and time the message was sent; a subject line; message text; a flag denoting if the message has been viewed. A secure message may be authored by the enterprise or customer 110. A secure message may be sent to one or more system-recognized entities. A secure message may be replied to with the reply being sent to the sender. Secure messages may be listed by sender, recipient, subject, sent date/time, viewed messages, unviewed messages, etc. Files may be attached to a secure message. Secure messages may be deleted, searched, and filed/archived in repository 108.

Marketing messages comprise campaign-based communications to a set of customers 110. Customer(s) 110 can respond to marketing messages (negatively, positively, or otherwise). A marketing message can have an associated marketing business process attached. The business process may be initiated upon a customer's response to a marketing message. Marketing messages may include reference to a number of times that the message should be shown on a particular channel 104. If a marketing message is sent to multiple channels 104, when a customer 110 responds on one channel, the marketing message will not be shown on the remaining channels. Marketing messages are channel aware and may have channel-specific presentations. Customers 110 may opt-out of receiving marketing messages.

An announcement is a planned communication activity to a mass audience. When an announcement is created, an activity is generated for each customer 110 and for each communication channel type. Announcements may have a status of Planned, Completed, Cancelled, or On Hold.

FIG. 4 illustrates a UML diagram of one implementation of MECMF 102. In the embodiment of FIG. 4, MECMF 102 comprises a message class 402, a channel-specific template class 404, a customer interaction class 406, an enterprise channel class 408, a customer class 410, a channel interaction class 412, a note class 414, and an interaction history class 416.

Customer interaction class 406 represents a customer interaction that is to occur in the future. Once the customer interaction has occurred, the status of customer interaction class 406 changes to ‘Completed’ and an interaction history class 416 may be created to record the results. One of ordinary skill in the art will appreciate that MECMF 102 may support any desirable interaction.

An interaction service may employ the following family of finder methods for returning all interactions for a customer, of a given message type, and on a given channel:
FindByPerson( )
FindByPerson_Type( )
FindByPerson_Channel( )
FindByPerson_Type_Channel( )
   The interaction service may also employ the following service methods:
MessageDisplayed(ObjectId objectId)
MessageAcknowledged(ObjectId objectId, Enumeration response)

A client-side helper class (e.g., InteractionTextHelper) may contain logic to retrieve the message text based on an InteractionPlannedValue object and a channel identifier.

The helper class may hold the logic to retrieve the text no matter how it is stored.

Interaction history class 416 represents a customer interaction that has occurred. An InteractionHistory can stand alone, or can be a result of a planned interaction.

Message class 402 represents a message to be presented to at least one of the customers 110 (customer class 410).

Channel-specific class 404 represents the channel-specific template of the content sent with a message.

Channel class 408 represents the method of communication with a customer 110. In other words, channel class 408 defines the channel 104 through which the message is to be delivered.

Customer class 410 represents an individual known to the enterprise (e.g., customer 110, enterprise employees, etc.)

Channel interaction class 412 holds the limit of times a planned interaction is allowed to be presented on a given channel. For example, the value of plannedChannelCount may be initialized to the maxShowCount field of the channel-specific class 404 for the matching channel 104. Every time the interaction is presented to the customer, the count is decremented until it is zero.

Channel interaction class 412 may be extended to manage the text of a customer interaction be delivered to a customer on a specific channel. The text may be personalized or not and is stored differently in each case. The management is achieved in conjunction with channel-specific class 404 on the same channel. If the text is personalized, then the text is held by an associated note (message text class 414). If the text is not personalized (i.e., all people will receive the same text on a channel), then the text is held by channel-specific class 404.

Message text class 414 represents a piece of text that may be personalized, optimized, etc. for a particular channel. The text contained in message text class 414 comprises the message content to be delivered to an individual on a given channel.

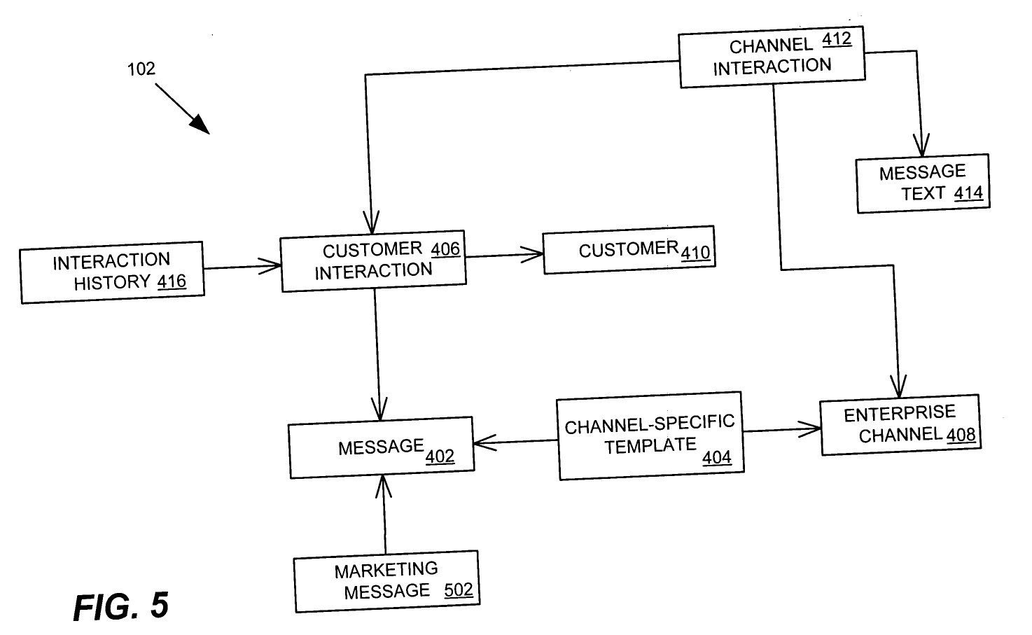

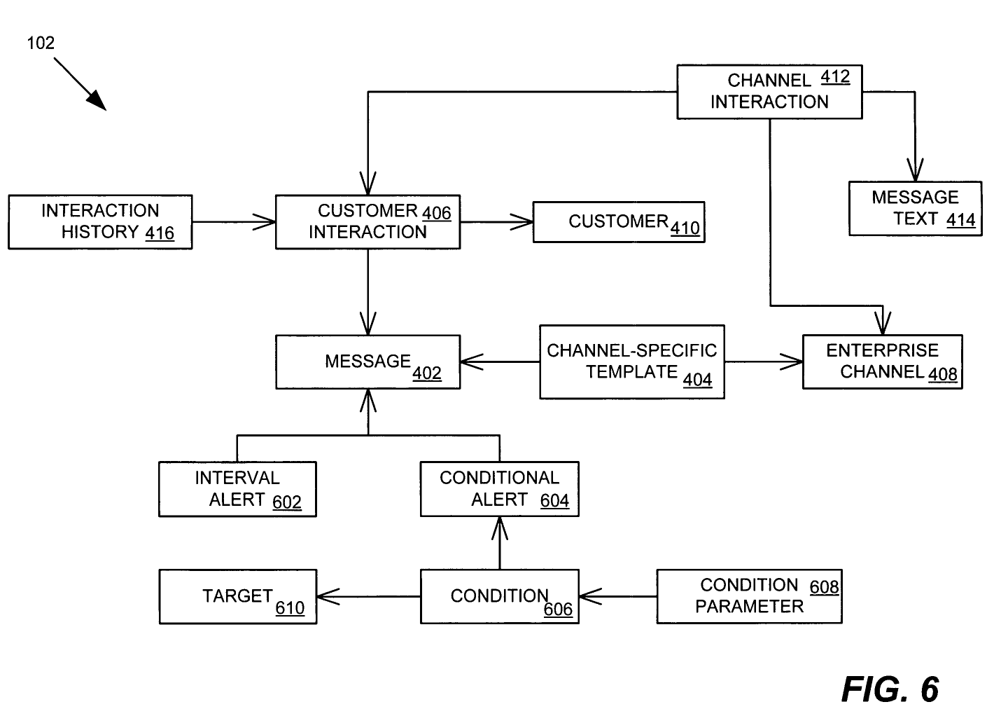

It should be appreciated that message class 402 may be extended to include various types of messages. As illustrated in FIG. 5, a marketing message class 502 may be added to MECMF 102 to support these services. Marketing message class 502 represents a planned outbound communication from the enterprise to a customer 110. The design of the alert-related services are illustrated in FIG. 6. In this embodiment, MECMF 102 further comprises an interval alert class 602, a conditional alert class 604, a condition class 606, a condition parameter class 608, and a target class 610.

As mentioned above, an alert encapsulates all categories of alert in MECMF 102, whether they are scheduled (interval alert class 602) or conditional in nature (conditional alert class 604). An alert may be triggered by a rule represented by condition class 606 and condition parameter class 608. A condition is set of comparisons for a target. Each comparison is represented by a ConditionParameter on the conditions target.

A ConditionParameter represents a comparison between a single target field (named) and a value using various comparison operators.

A Target is used to supply a set of values (i.e., its fields) for a Condition. Each Condition is related to one Target. A Target can be related to zero-to-many Conditions.

A Target represents an instance of any type in the system. The reference may be described by a type enum and an object id. This data is sufficient to obtain a reference to an object instance where the Domain Class is described in Metadata.

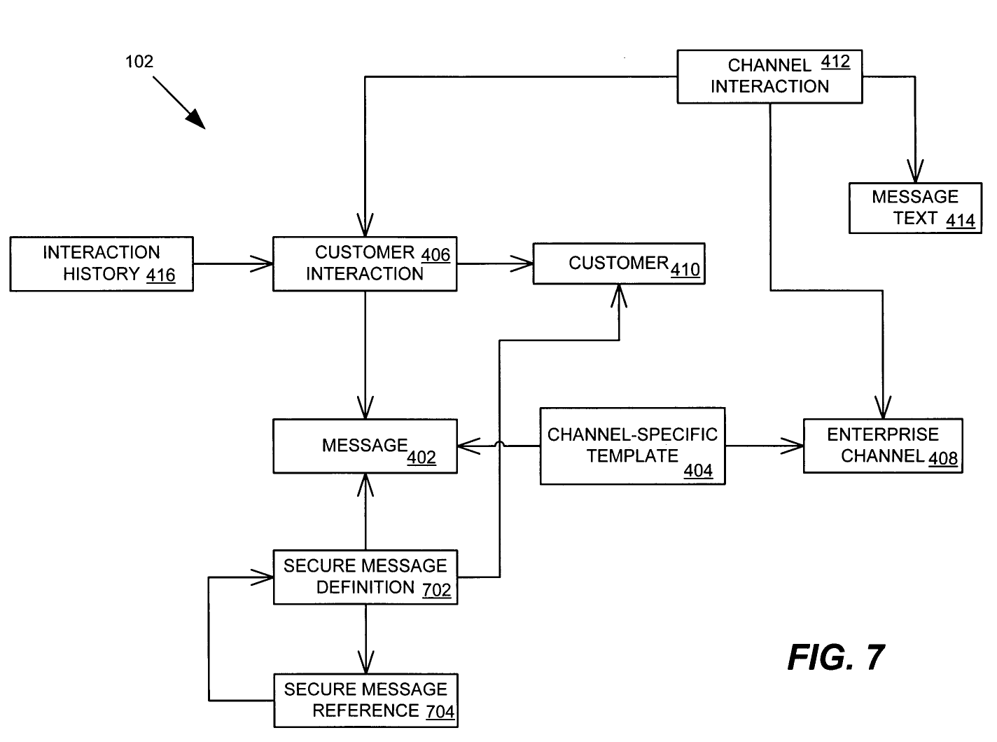

The design of the secure messages service is illustrated in FIG. 7. In this embodiment, MECMF 102 includes a secure message definition class 702 and a secure message reference class 704. A SecureMessage is the central object in the secure message. It represents a message sent from the sender to a receiver. There is only one sender—the author. There may be many receivers, each represented by a CustomerInteraction (customer interaction class 406) with a link to a Customer (customer class 410). The text of the message sent to each recipient is the same, so a Note (note class 414) may be attached to the SecureMessage. Because the message is only sent to a single channel, the channel-centric relationships (channel-specific class 404, channel interaction class 412, channel class 408) may not be included.

A SecureMessage can refer to a previous message through a SecureMessageRef (class 704). A SecureMessageRef relates one SecureMessage to a previous one (e.g., a response to a message).

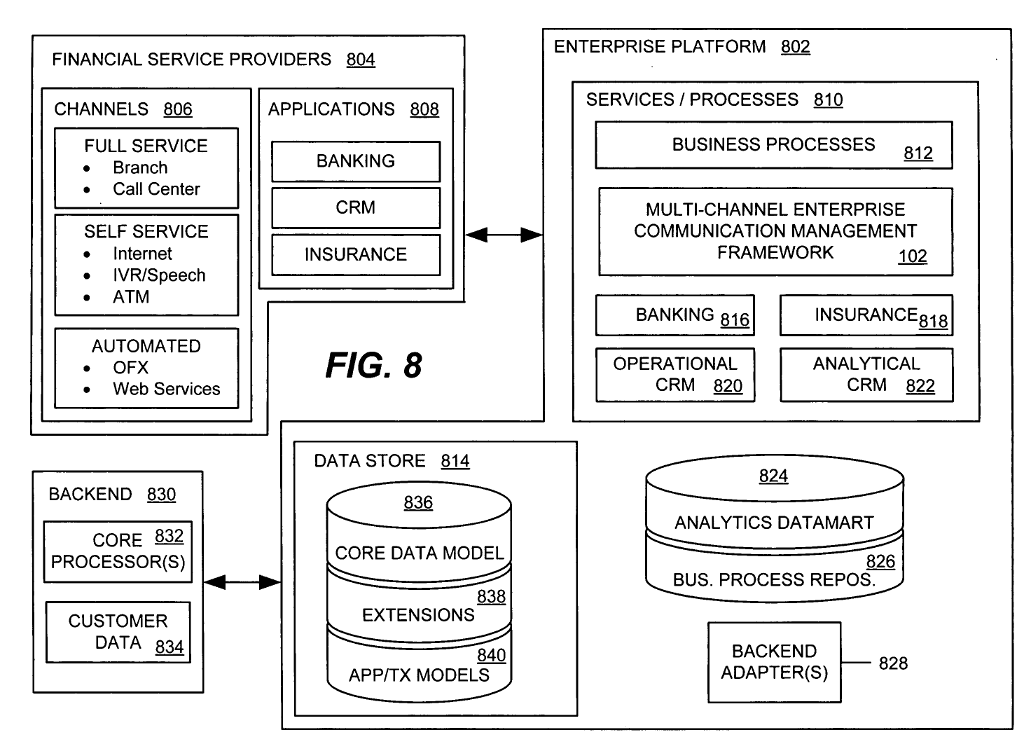

FIG. 8 illustrates another embodiment of an enterprise system for implementing a MECMF 102. In this embodiment, MECMF 102 is integrated in an enterprise platform 802 that functions as a front-office to financial service providers 804. Enterprise platform 802 is configured according to a service-oriented architecture and applications 808 are configured using a set of underlying building blocks, components, etc. called services.

These individual services are components that are put together in a flexible manner to deliver the desired business logic. As an added form of flexibility, the business logic can be exposed as a set of easily adaptable business processes, which, when paired with the appropriate user interfaces, make up an application 808, which is then typically accessed through one or more enterprise channels 806.

The overall 50A promotes reuse within applications 808 as well as without. Because these services are accessible via industry-standard web services interfaces, these building blocks can be reused by the enterprise applications 808 to form a more seamless solution to financial service providers 804.

Enterprise platform 802 employs a service-oriented architecture to provide services/processes 810 to applications 808 across channels 806. Applications 808 may include any suitable banking application. Applications 808 comprise groupings of specific features, functions, business processes, etc. In the embodiment illustrated in FIG. 8, applications 808 include banking-related application(s), customer relationship management (CRM) application(s), insurance applications, etc. Enterprise platform 802 includes corresponding services/processes for supporting each type of application (e.g., banking services 816, insurance services 818, operational CRM 820, and analytical CRM 822).

As further illustrated in FIG. 8, financial service providers 804 may use various channels 806 to support applications 808. Channels 806 provide the conduits of interaction with enterprise platform 802. For example, different channels 806 may require specific presentation logic in order to implement applications 808. Financial service providers 804 may include full-service channels (e.g., branch, call center, etc.) for human-to-human interactions, self-service channels (e.g., Internet, IVR/speech, ATM, etc.) for human-to-machine interaction, and automated channels (e.g., OFX, IFX, web services, etc.) for machine-to-machine interaction.

Enterprise platform 802 includes a data store 814 for storing core data model 836, extensions 838, and application/transaction data model(s) 840. Core data model 836 comprises a customer-centric, application-neutral data model. Applications 808 (and other third parties) may extend core data model 836 to specialize their data and their behaviors (extensions 838). Application/transaction data model(s) 840 may be owned by specific applications 808 and may not be published or meant to be extended, except through an application software development kit (SDK).

Enterprise platform 802 also includes analytics datamart 824 and business process repository 826. Datamart 824 comprises a component used for analytical processing on data sourced from a variety of systems. Business process repository 826 stores definitions of application-specific and/or common processes.

As further illustrated in FIG. 8, enterprise platform 802 may include various adapters (e.g., backend adapters 828) for providing front-office access to a backend 830 containing core processors 832 and customer data 834. Backend 830 may comprise any host system or other system of record. Adapters 828 may operate in four different modes: real-time; real-time with batch back-up; hybrid; and batch. In real-time mode, applications and services go immediately to backend 830. No data is stored locally and services are only available if backend 830 is available. In real-time/batch back-up mode, applications and services go immediately to backend 830. Data is stored locally as a back-up, but used only if backend 830 becomes unavailable. In hybrid mode, access to a specific backend system is configured so that some transactions are accessed in real-time, whereas others are accessed in batch mode. In batch mode, no real-time access to backend 830 is available. The local database acts as a stand-in for the backend system and appropriate synchronization occurs.

One of ordinary skill in the art will appreciate that enterprise platform 802 may be designed using a set of common services and frameworks. In one embodiment, enterprise platform 802 is built on a COTS J2EE application server. It should be further appreciated that services/processes 810 may be implemented using various technologies, including but not limited to, XML, SOAP, WSDL, UDDI, etc. It should be further appreciated, however, that alternative embodiments may include other technologies.

Although this disclosure describes various embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. An enterprise system comprising:
a plurality of enterprise applications for interacting with customers via a plurality of channels; and
a communication management framework for managing messages to be presented to the customers and customer responses to the messages across the plurality of enterprise applications.

2. The enterprise system of claim 1, further comprising a data repository for storing the messages and the customer responses to the messages.

3. The enterprise system of claim 1, wherein the communication management framework is configured to service a message delivery request from at least one of the plurality of enterprise applications.

4. The enterprise system of claim 1, wherein the communication management framework is integrated with an enterprise platform that functions as a front-end provider of services to the plurality of enterprise applications.

5. The enterprise system of claim 1, wherein the communication management framework comprises:
a message object defining a message to be presented to at least one of the customers;
a channel-specific object representing channel-specific content associated with the message; and
a customer interaction object representing a planned customer interaction associated with the message.

6. The enterprise system of claim 5, wherein the message object defines at least one of a marketing message, an interval alert, a conditional alert, and a secure message.

7. The enterprise system of claim 5, wherein the communication management framework further comprises:
an interaction history object representing actual customer interactions associated with the message;
a customer object representing the at least one customers to receive the message; and
an enterprise channel object representing at least one of the plurality of channels through which the message is to be delivered.

8. The enterprise system of claim 7, wherein the communication management framework further comprises a channel interaction object defining a maximum number of times the planned customer interaction may be presented to the at least one customer via the at least one of the plurality of channels through which the message is to be delivered.

9. The enterprise system of claim 1, wherein the communication management framework comprises an interface for receiving message delivery requests from the plurality of applications and for receiving the customer responses to the messages.

10. The enterprise system of claim 1, wherein at least one of the plurality of channels comprises one of a full-service channel, a self-service channel, and an automated channel.

11. The enterprise system of claim 1, wherein at least one of the plurality of channels comprises an interactive voice response (IVR) channel, an Internet channel, an automated teller machine (ATM) channel, and a bank teller channel.

12. A service-oriented, enterprise platform for providing banking solutions to financial service providers, the service-oriented, enterprise platform comprising:
a communication management framework for managing messages to be presented to customers of a financial service provider across a plurality of enterprise channels and for managing customer responses to the messages, the communication management framework comprising:
a message object defining a message to be presented to at least one of the customers;
a channel-specific object representing channel-specific content associated with the message; and
a customer interaction object representing a planned customer interaction associated with the message; and
a data repository for storing the messages and the customer responses to the messages.

13. The service-oriented, enterprise platform of claim 12, wherein the message object defines at least one of a marketing message, an interval alert, a conditional alert, and a secure message.

14. The service-oriented, enterprise platform of claim 12, wherein the communication management framework further comprises:
an interaction history object representing actual customer interactions associated with the message;
a customer object representing the at least one customers to receive the message; and
an enterprise channel object representing at least one of the plurality of channels through which the message is to be delivered.

15. The service-oriented, enterprise platform of claim 14, wherein the communication management framework further comprises a channel interaction object defining a maximum number of times the planned customer interaction may be presented to the at least one customer via the at least one of the plurality of channels through which the message is to be delivered.

16. A multi-channel enterprise communication management framework (MECMF) embodied in a computer-readable medium for unifying customer messages and responses in an enterprise across a plurality of channels, the (MECMF) comprising:
a message object defining a message to be presented to at least one of the customers;
a channel-specific object representing channel-specific content associated with the message; and
a customer interaction object representing a planned customer interaction associated with the message.

17. The MECMF of claim 16, wherein the message object defines at least one of a marketing message, an interval alert, a conditional alert, and a secure message.

18. The MECMF of claim 16, further comprising:
an interaction history object representing actual customer interactions associated with the message;
a customer object representing the at least one customers to receive the message; and
an enterprise channel object representing at least one of the plurality of channels through which the message is to be delivered.

19. The MECMF of claim 18, further comprising a channel interaction object defining a maximum number of times the planned customer interaction may be presented to the at least one customer via the at least one of the plurality of channels through which the message is to be delivered.

20. The MECMF of claim 16, wherein at least one of the plurality of channels comprises an interactive voice response (IVR) channel, an Internet channel, an automated teller machine (ATM) channel, and a bank teller channel.
